(19) United States
(12) Patent Application Publication
(10) Pub. No.: US 2025/0050521 A1
(43) Pub. Date: Feb. 13, 2025

(54) SHAVING RAZOR CARTRIDGE

(71) Applicant: The Gillette Company LLC, Boston, MA (US)

(72) Inventor: Donald William Loughlin, Natick, MA (US)

(21) Appl. No.: 18/231,037

(22) Filed: Aug. 7, 2023

(51) Int. Cl. B26B 21/40

(52) U.S. Cl. CPC B26B 21/4012; B26B 21/4068; B26B 21/222

(57) ABSTRACT

A shaving razor cartridge. The shaving razor cartridge includes a housing having a front portion and a rear portion and at least one blade having a respective cutting edge. The at least one blade is retained within the housing between the front portion and the rear portion and is positioned between the front portion and the rear portion. At least one of the front portion and the rear portion has a first plurality of grooves extending from a top surface of the housing to a base of the groove. The first plurality of grooves each have a width of 20 μm to 100 μm at the top surface and extend a depth of 10 μm to 100 μm from the base to the top surface.

### FIELD OF THE INVENTION

The present invention relates to shaving razors and more particularly to shaving razor cartridges for shaving razors.

### BACKGROUND OF THE INVENTION

Most razors available to consumers include a head or shaving razor cartridge where the friction of the shaving razor cartridge as it passes over the skin of the user during shaving is managed with a combination of placing a low durometer elastomeric material at the leading edge of the housing, to increase friction and create skin stretch, and placing soap or a lubricating material at the trailing edge of the housing, to decrease friction and create the feeling of glide. However, these technologies for managing the friction of the shaving razor cartridge add the cost of additional components and incorporate the use of plastic-based material, which is not considered sustainable.

Therefore, a shaving razor cartridge, and particularly a housing for a shaving razor cartridge, is needed that controls the friction as the shaving razor cartridge passes over the skin without using additional components and, preferably, without using plastic-based materials.

### SUMMARY OF THE INVENTION

The present invention relates to a shaving razor cartridge and to methods of forming a shaving razor cartridge and of forming housing for a shaving razor cartridge.

In one implementation, the shaving razor cartridge can comprise a housing having a front portion and a rear portion and at least one blade having a respective cutting edge. The at least one blade is retained within the housing and positioned between the front portion and the rear portion. At least one of the front portion and the rear portion of the housing has a first plurality of grooves extending from a top surface of the housing to a base of the groove. The first plurality of grooves each have a width of 20 μm to 100 μm at the top surface and extend a depth of 10 μm to 100 μm from the base to the top surface.

The widths of the first plurality of grooves can extend perpendicular to the at least one blade and the first plurality of grooves each have a length extending parallel to the at least one blade of 1 mm to 40 mm.

The at least one of the front portion and the rear portion can have a second plurality of grooves extending from the top surface to a base of the groove. The second plurality of grooves can each have a width of 20 μm to 100 μm at the top surface, extend a depth of 10 μm to 100 μm from the base to the top surface, and have a length that extends at an angle between 45 degrees and 75 degrees relative to the lengths of the first plurality of grooves.

The first plurality of grooves and the second plurality of grooves can be in the front portion of the housing.

The first plurality of grooves can be in the rear portion of the housing.

The widths of the first plurality of grooves can extend parallel to the at least one blade and the first plurality of grooves can each have a length extending perpendicular to the at least one blade of 1 mm to 8 mm at the top surface.

The widths of the first plurality of grooves can extend perpendicular to the at least one blade and the first plurality of grooves can each have a length extending parallel to the at least one blade of 1 mm to 40 mm at the top surface.

The rear portion can have a second plurality of grooves extending from the top surface to a base of the groove. The second plurality of grooves can each have a width of 20 μm to 100 μm at the top surface, extend a depth of 10 μm to 100 μm from the base to the top surface, and have a length that extends at an angle of 90 degrees relative to the lengths of the first plurality of grooves.

The shaving razor cartridge can have a blade platform, the at least one blade can be mounted to the blade platform, and the housing can cover the blade platform.

The first plurality of grooves can be spaced apart by a distance of 20 μm to 100 μm.

The first plurality of grooves can each have a width extending parallel to the at least one blade of 40 μm to 80 μm at the top surface.

The first plurality of grooves can have a taper angle from the base to the top surface of 0 degrees to 30 degrees.

The first plurality of grooves can have a density of 10 to 50 grooves per mm² and cover an area of 50 mm² to 300 mm² of the top surface of the housing.

In another implementation, the method of forming a housing for a shaving razor cartridge can comprise: forming a housing blank from a sheet metal substrate; forming an elongated window in the sheet metal substrate; and removing material from a surface of the sheet metal substrate adjacent the elongated window to a depth of 10 μm to 100 μm by laser ablation along a first continuous path to form a first groove.

Removing material can comprise laser ablating at least 25% of a total area of at least 100 mm².

The method can comprise removing material from the surface of the sheet metal substrate adjacent the elongated window to a depth of 10 μm to 100 μm by laser ablation along a second continuous path to form a second groove parallel to the first groove and spaced apart from the first groove by 20 μm to 100 μm.

The method can comprise removing material from the surface of the sheet metal substrate adjacent the elongated window to a depth of 10 μm to 100 μm by laser ablation along a second continuous path to form a second groove perpendicular to the first groove.

The method can comprise removing material from the surface of the sheet metal substrate adjacent the elongated window to a depth of 10 μm to 100 μm by laser ablation along a second continuous path to form a second groove having a length that extends at an angle between 45 degrees and 75 degrees relative to a length of the first groove.

A length of the first groove can be parallel to a length of the elongated window and extend at least 50% of the length of the window.

In another implementation, the method of forming a shaving razor cartridge can comprise: forming a housing blank from a sheet metal substrate; forming an elongated window in the sheet metal substrate; forming a housing by forming one or more curved surfaces on the housing blank; removing material from a surface of the sheet metal substrate to a depth of 10 μm to 100 μm by laser ablation along a first continuous path; mounting one or more blades to a blade platform; and covering the blade platform with the housing.

### BRIEF DESCRIPTION OF THE DRAWINGS

While the specification concludes with claims particularly pointing out and distinctly claiming the subject matter that is regarded as forming the present invention, it is believed that the invention will be better understood from the following description, which is taken in conjunction with the accompanying drawings in which like designations are used to designate substantially identical elements, and in which:

FIG. 1 is a front perspective view of an example shaving razor;

FIG. 2 is an exploded view of the shaving razor of FIG. 1;

FIG. 3A is a front perspective view of a first example housing for use in the shaving razor of FIG. 1 with a first plurality of grooves formed on a front portion;

FIG. 3B is a rear perspective view of the housing of FIG. 3A with the first plurality of grooves formed on a rear portion;

FIG. 3C is a front perspective view of the housing of FIG. 3A with the first plurality of grooves formed on the front portion and the rear portion;

FIG. 3D is an enlarged view of a portion of the housing of FIG. 3B;

FIG. 3E is a cross-sectional view of a portion of the housing of FIG. 3D taken along the line 3E of FIG. 3D;

FIG. 4A is a front perspective view of a second example housing for use in the shaving razor of FIG. 1 with a first plurality of grooves formed on a front portion;

FIG. 4B is a rear perspective view of the housing of FIG. 4A with the first plurality of grooves formed on a rear portion;

FIG. 4C is a front perspective view of the housing of FIG. 4A with the first plurality of grooves formed on the front portion and the rear portion;

FIG. 4D is an enlarged view of a portion of the housing of FIG. 4B;

FIG. 4E is a cross-sectional view of a portion of the housing of FIG. 4D taken along the line 4E of FIG. 4D;

FIG. 5A is a front perspective view of a third example housing for use in the shaving razor of FIG. 1 with a first plurality of grooves and a second plurality of grooves formed on a front portion;

FIG. 5B is a rear perspective view of the housing of FIG. 5A with the first plurality of grooves and the second plurality of grooves formed on a rear portion;

FIG. 5C is a front perspective view of the housing of FIG. 5A with the first plurality of grooves and the second plurality of grooves formed on the front portion and the rear portion;

FIG. 5D is an enlarged view of a portion of the housing of FIG. 5B;

FIG. 5E is a cross-sectional view of a portion of the housing of FIG. 5D taken along the line 5E of FIG. 5D;

FIG. 6A is a front perspective view of a fourth example housing for use in the shaving razor of FIG. 1 with a first plurality of grooves and a second plurality of grooves formed on a front portion;

FIG. 6B is a rear perspective view of the housing of FIG. 6A with the first plurality of grooves and the second plurality of grooves formed on a rear portion;

FIG. 6C is a front perspective view of the housing of FIG. 6A with the first plurality of grooves and the second plurality of grooves formed on the front portion and the rear portion;

FIG. 6D is an enlarged view of a portion of the housing of FIG. 6B;

FIG. 6E is a cross-sectional view of a portion of the housing of FIG. 6D taken along the line 6E of FIG. 6D;

FIG. 7 is a flowchart illustrating an example method for forming a housing for a shaving razor cartridge, and

FIG. 8 is a flowchart illustrating an example method for forming a shaving razor cartridge.

### DETAILED DESCRIPTION OF THE INVENTION

The examples described herein relate to shaving razor cartridges and methods of forming shaving razor cartridges and of forming housings for shaving razor cartridges. The example shaving razor cartridges herein can include housings that have micro-patterns etched into one or more surfaces of the housing by laser ablation/etching to make the surface(s) hydrophilic or hydrophobic and to increase or decrease the friction between the shaving razor cartridge and the skin of a user during shaving. The example housings of the shaving razor cartridges herein are preferably metal, to reduce the use of plastic-based materials, but could also be plastic, which would still reduce the number of components used in the shaving razor cartridge.

Various patterns could be etched into the front and/or rear portion of the housing of the shaving razor cartridge to increase friction and create skin stretch or to decrease friction and create the feeling of glide, depending on the particular application. It is believed, without being held to theory, that some of the surface textures disclosed facilitate the trapping of water and shaving aid that a consumer may use for shaving on the surface of the shaving razor cartridge, as well as removing some of the higher friction metal material from the shaving surface, thus lowering surface friction and improving glide for a more comfortable shave. In addition, the surface textures may also be easily rinsed clean between shaves (e.g., surface texture does not trap shaving debris). It is believed, without being held to theory, that some of the surface textures disclosed may alternatively facilitate the gripping of the skin during a shaving stroke, thus improving skin stretch for a closer and more comfortable shave.

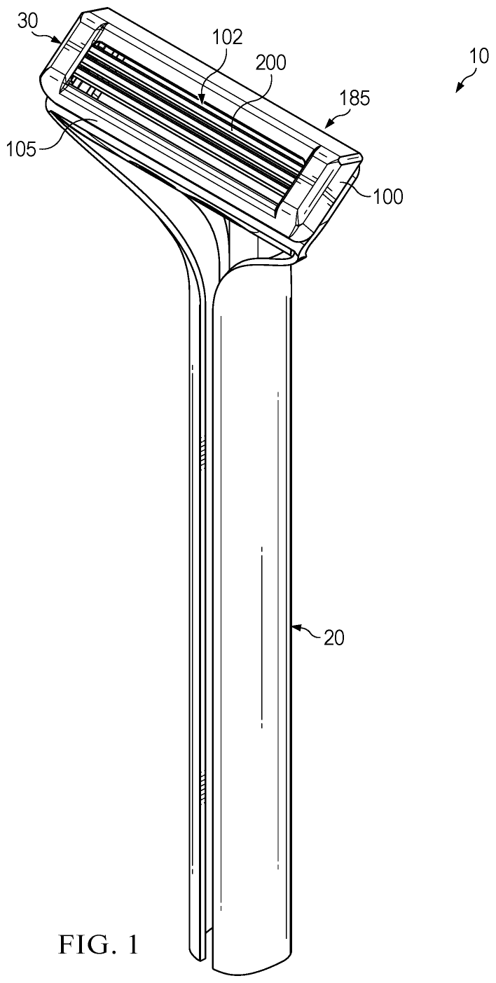

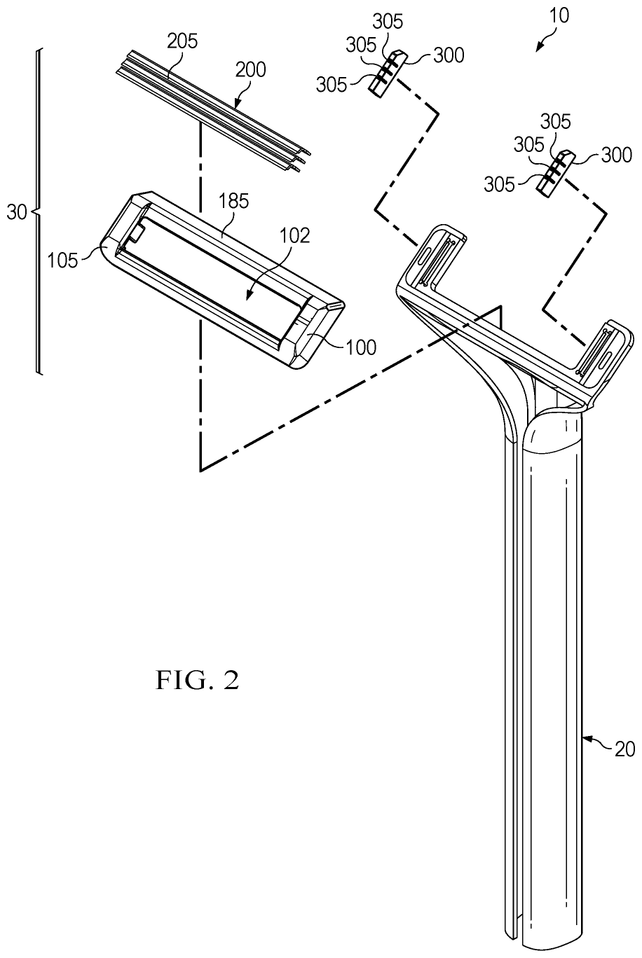

Referring to FIGS. 1-2, an example shaving razor 10 is shown, which generally includes a handle 20 and a shaving razor cartridge 30, which can be connected to, or removably connected to, handle 20. Shaving razor cartridge 30 generally includes a housing 100, which is preferably a metal material, such as aluminum, anodized aluminum, stainless steel, titanium, etc. with a Brinell hardness of 30 to 100, a blade platform 300, and at least one blade 200 having a respective cutting edge 205. A metal housing 100 may facilitate the formation of smaller and more precise features by laser ablation than is typically possible by injection molding plastic materials or machining or laser ablation of plastics. As shown, blades 200 can be mounted to blade platform 300 by positioning blades 200 within slots 305 formed in blade platform 300. Housing 100 can cover blade platform 300 such that blades 200 are retained within housing 100, are positioned between a front portion 105 and a rear portion 185 of housing 100, and are accessible through an elongated window 102 formed in housing 100 between front portion 105 and rear portion 185. As referred to herein, front portion 105 of housing 100 is the portion of housing 100 that engages the skin of a user before blades 200 and rear portion 185 of housing 100 is the portion of housing 100 that engages the skin of the user after blades 200.

Although the particular example shaving razor cartridge 30 is shown and described herein as having housing 100 and a separate blade platform 300, it is understood that the housing and blade platform could be formed together as a single, integral housing that holds the blades and has front and rear surfaces to receive the laser ablation/etching shown and described herein.

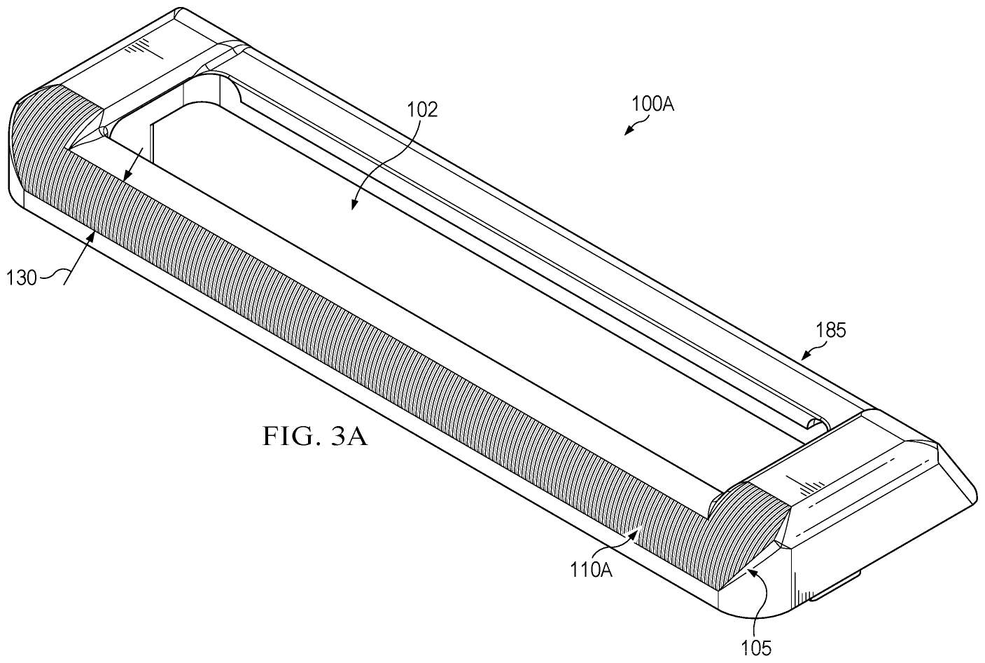

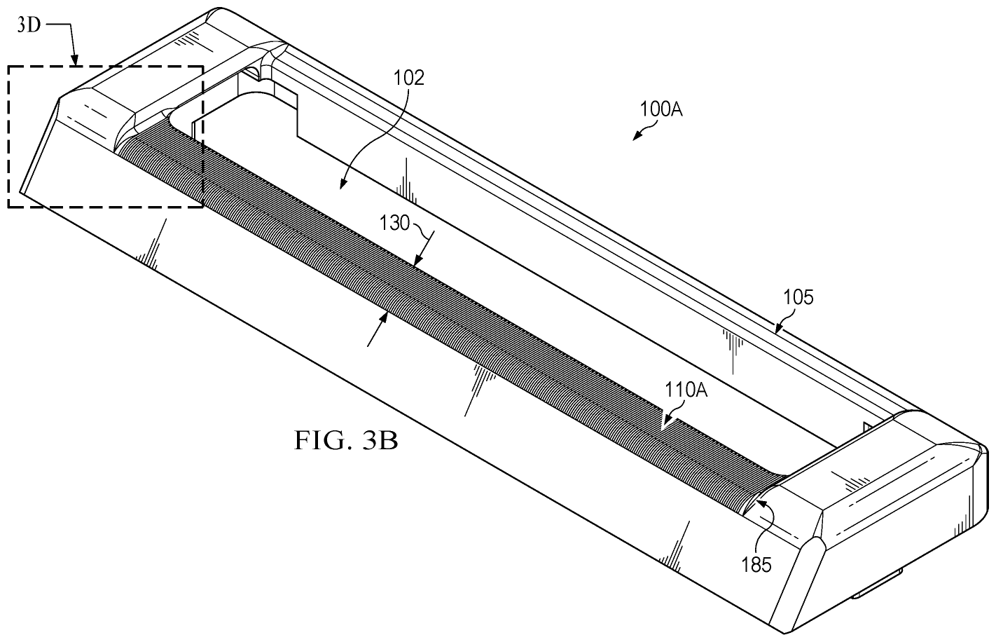

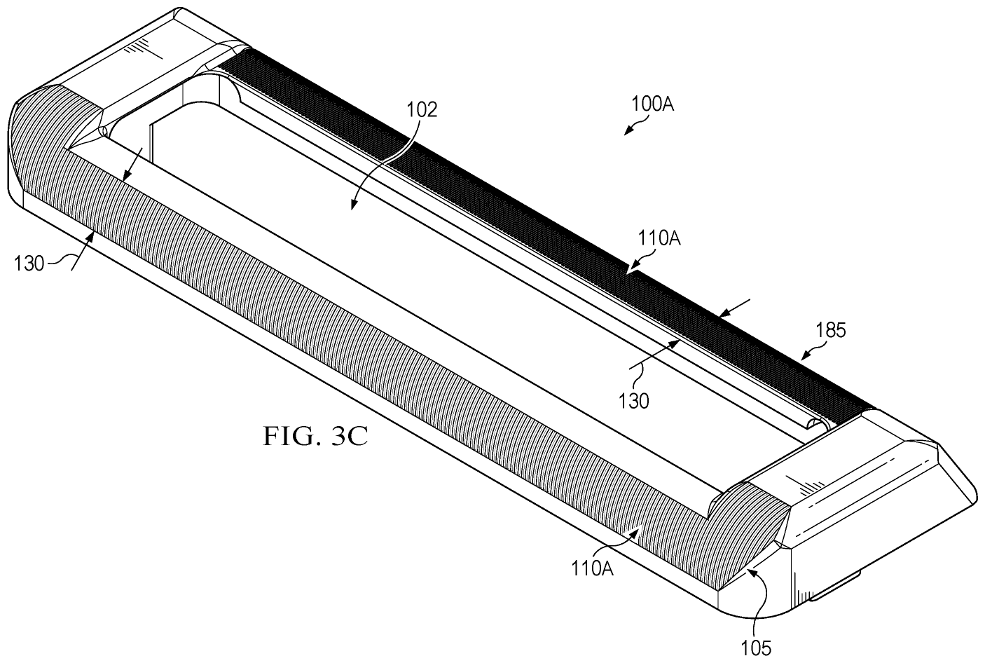

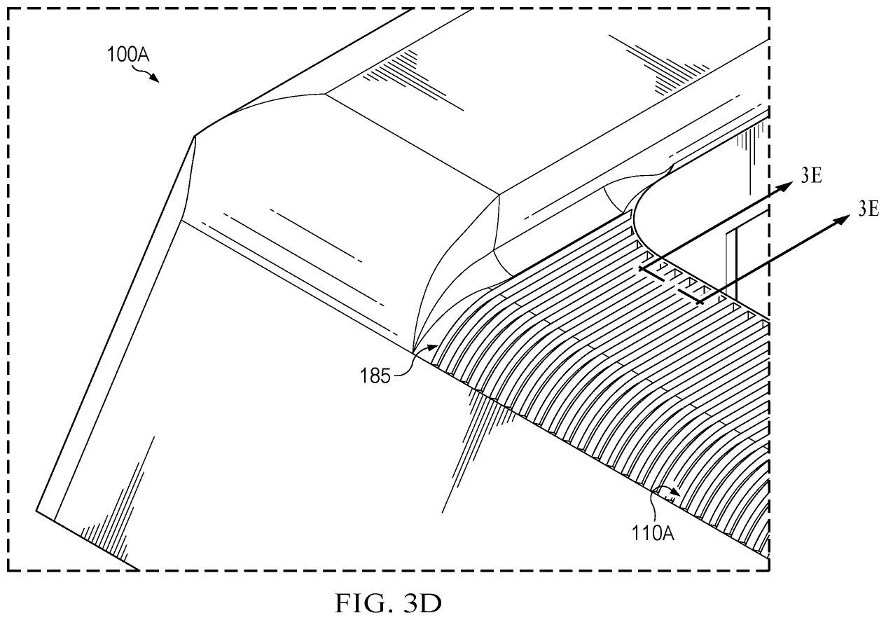

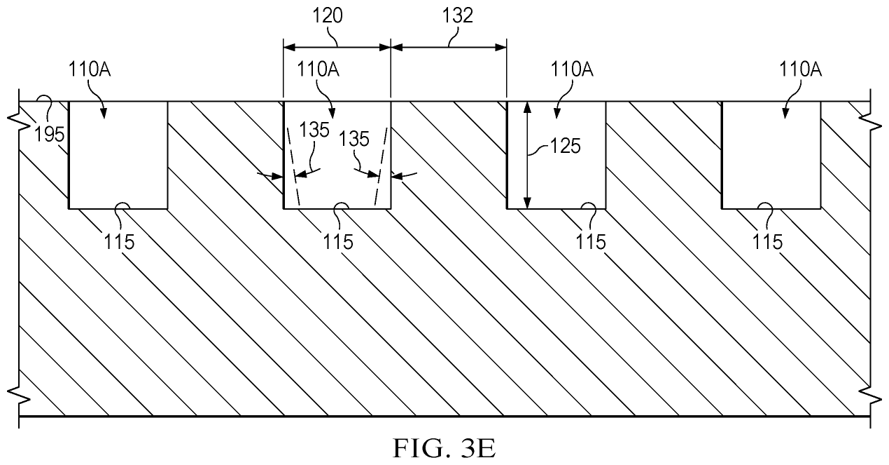

Referring to FIGS. 3A-3E, example housing 100A is illustrated that includes a first plurality of grooves 110A that each have a width 120 that extends generally parallel to cutting edges 205 of blades 200 and a length 130 that extends generally perpendicular to cutting edges 205 of blades 200. First plurality of grooves 110A can be formed in front portion 105 (FIG. 3A), rear portion 185 (FIG. 3B), or front portion 105 and rear portion 185 (FIG. 3C) of housing 100A, for example, by laser ablation. In one example, the laser ablation could be performed by an ultrashort pulse laser set at a power setting of 8 μJ and a wavelength of 1030 nm. The beam diameter used could be approximately 50% of the depth of the grooves being formed.

First plurality of grooves 110A each extend from a top surface 195 of housing 100A to a base 115 of each groove of first plurality of grooves 110A and can have a depth of 10 μm to 100 μm from top surface 195 to base 115 and a taper angle 135 between 0 degrees and 30 degrees from base 115 to top surface 195. Width 120 of each of first plurality of grooves 110A can be 20 μm to 100 μm at top surface 195, preferably between 40 μm and 80 μm, and length 130 of each of first plurality of grooves 110A can extend between 1 mm and 8 mm at top surface 195, depending on the size of housing 100A. First plurality of grooves 110A can be spaced apart by a distance 137 of 20 μm to 100 μm, preferably 40 μm to 80 μm, have a density of 10 to 50 grooves per mm², and cover an area of 50 mm² to 300 mm² of top surface 195.

Testing has shown that an aluminum plate having a plurality of parallel grooves (e.g., first plurality of grooves 110A) laser ablated/etched into the surface provides a generally hydrophilic surface. In addition, an aluminum plate having a plurality of parallel grooves (e.g., first plurality of grooves 110A) laser ablated/etched into the surface and having a length oriented perpendicular to the blades (e.g., parallel to the direction of travel over the skin) has a lower coefficient of friction, on average, than an aluminum plate with no surface texturing with the surface dry, wetted with water, and wetted with a shaving aid solution. Therefore, providing a plurality of parallel grooves (e.g., first plurality of grooves 110A) laser ablated/etched into the front portion and/or rear portion of a housing of a shaving razor cartridge will allow the housing to glide over the skin of a user more smoothly and easily than a housing with no textured surfaces.

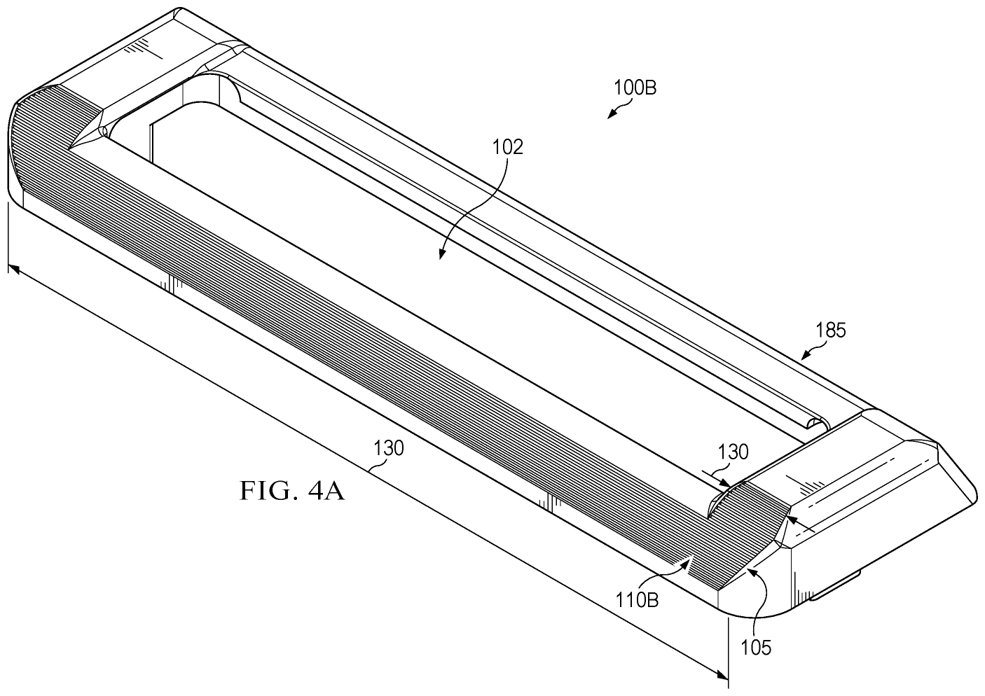

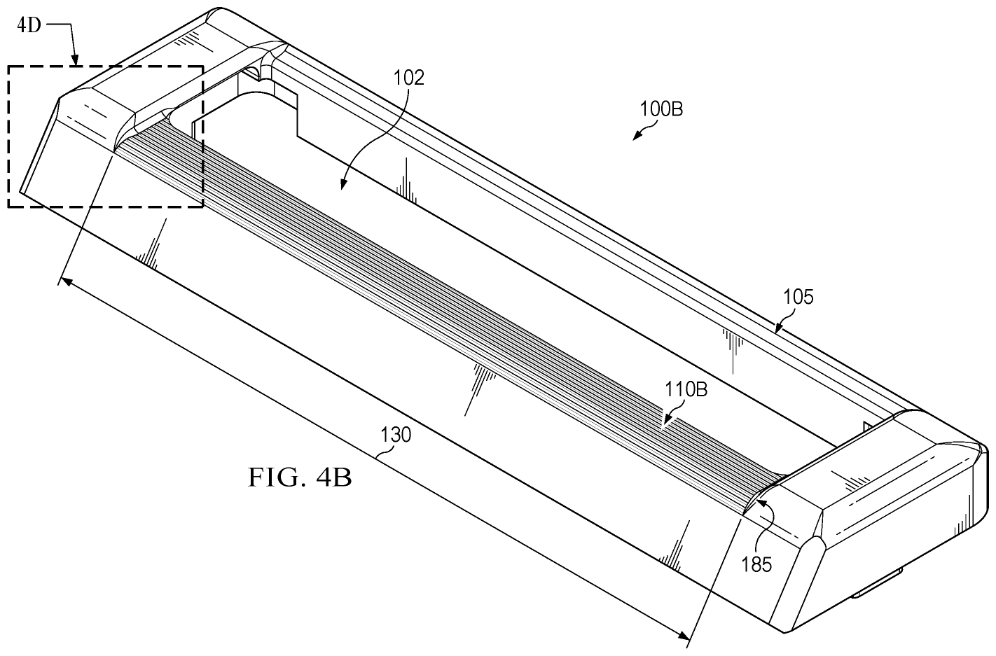

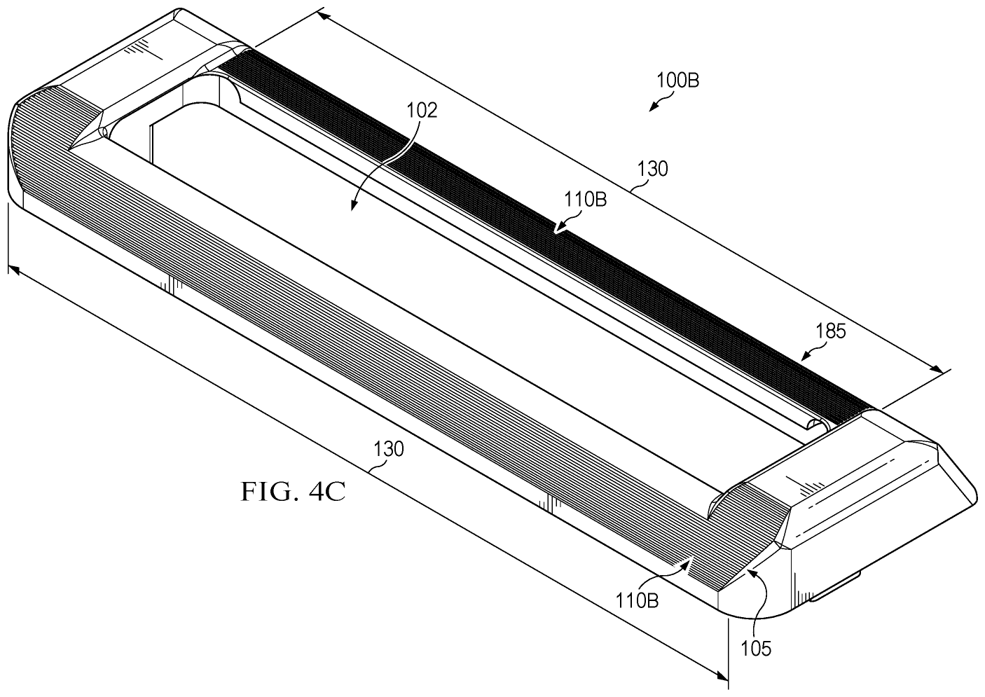

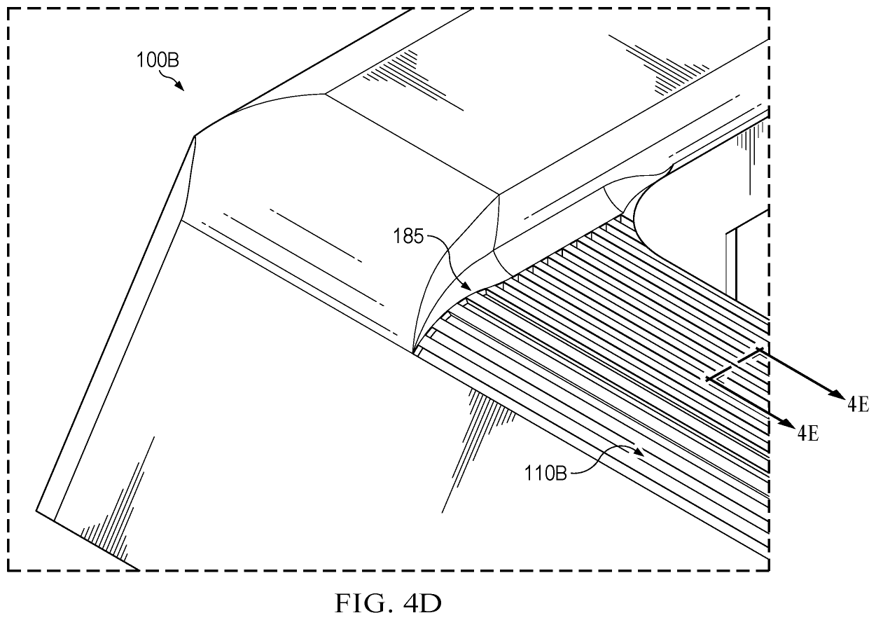

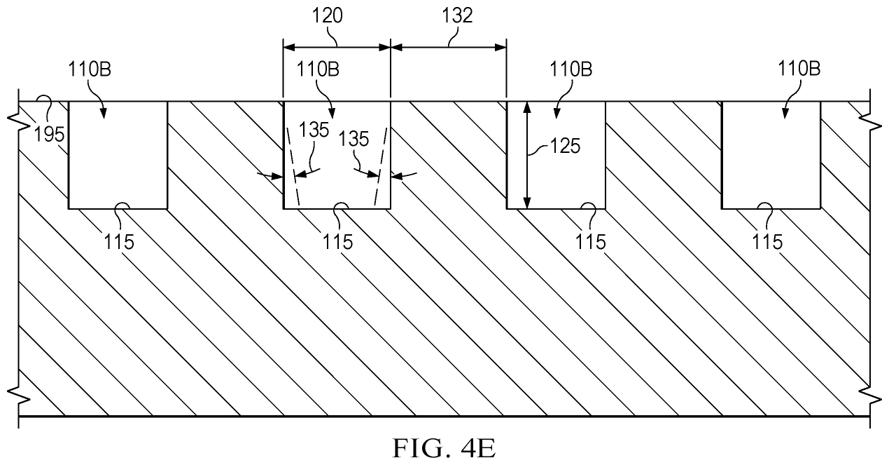

Referring to FIGS. 4A-4E, example housing 100B is illustrated that includes a first plurality of groove 110B that each have a width 120 that extends generally perpendicular to cutting edges 205 of blades 200 and a length 130 that extends generally parallel to cutting edges 205 of blades 200. First plurality of grooves 110B can be formed in front portion 105 (FIG. 4A), rear portion 185 (FIG. 4B), or front portion 105 and rear portion 185 (FIG. 4C) of housing 100B, for example, by laser ablation.

First plurality of grooves 110B each extend from a top surface 195 of housing 100B to a base 115 of each groove of the first plurality of grooves 110B and can have a depth of 10 μm to 100 μm from top surface 195 to base 115 and a taper angle 135 between 0 degrees and 30 degrees from base 115 to top surface 195. Width 120 of each of first plurality of grooves 110B can be 20 μm to 100 μm at top surface 195, preferably between 40 μm and 80 μm, and length 130 of each of first plurality of grooves 110B can extend between 1 mm and 40 mm at top surface 195, depending on the size of housing 100B. First plurality of grooves 110B can be spaced apart by a distance 137 of 20 μm to 100 μm, preferably 40 μm to 80 μm, have a density of 10 to 50 grooves per mm², and cover an area of 50 mm² to 300 mm² of top surface 195.

Testing has shown that an aluminum plate having a plurality of parallel grooves (e.g., first plurality of grooves 110B) laser ablated/etched into the surface provides a generally hydrophilic surface. In addition, an aluminum plate having a plurality of parallel grooves (e.g., first plurality of grooves 110B) laser ablated/etched into the surface and having a length oriented parallel to the blades (e.g., perpendicular to the direction of travel over the skin) has a lower coefficient of friction, on average, than an aluminum plate with no surface texturing with the surface dry, wetted with water, and wetted with a shaving aid solution. Therefore, providing a plurality of parallel grooves (e.g., first plurality of grooves 110B) laser ablated/etched into the front portion and/or rear portion of a housing of a shaving razor cartridge will allow the housing to glide over the skin of a user more smoothly and easily than a housing with no textured surfaces.

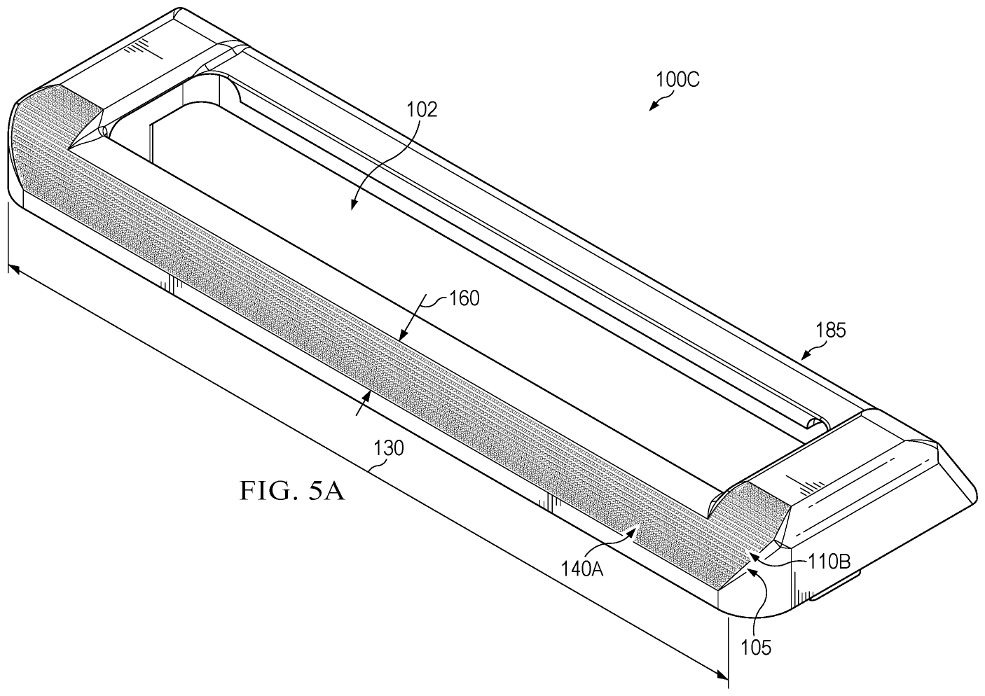

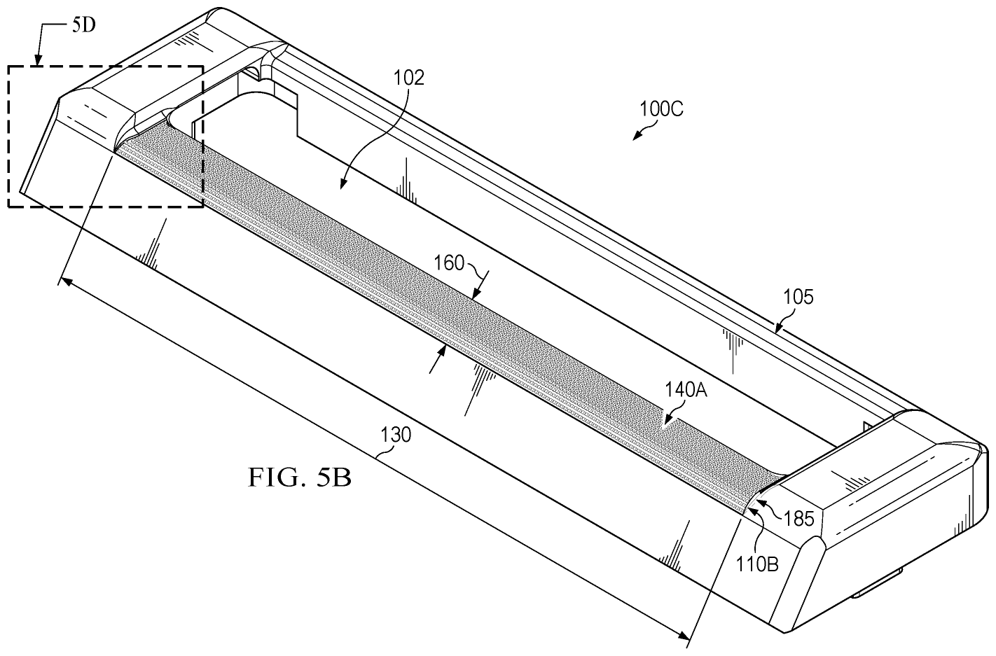

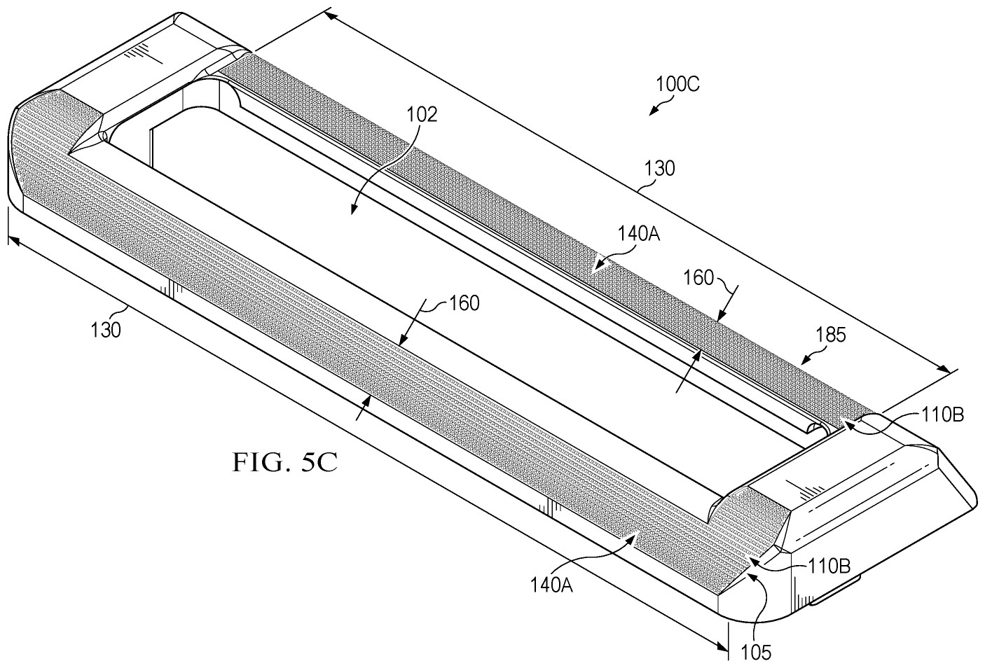

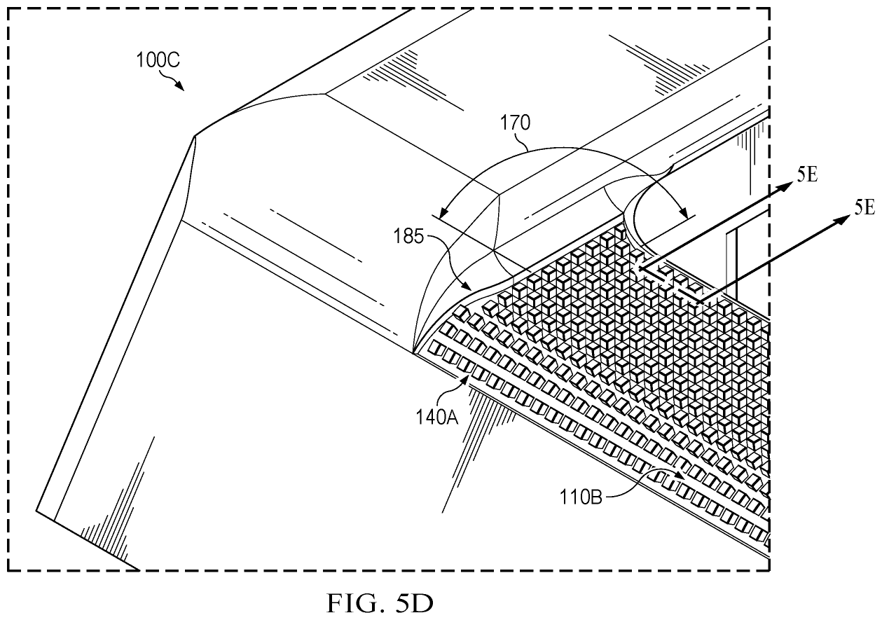

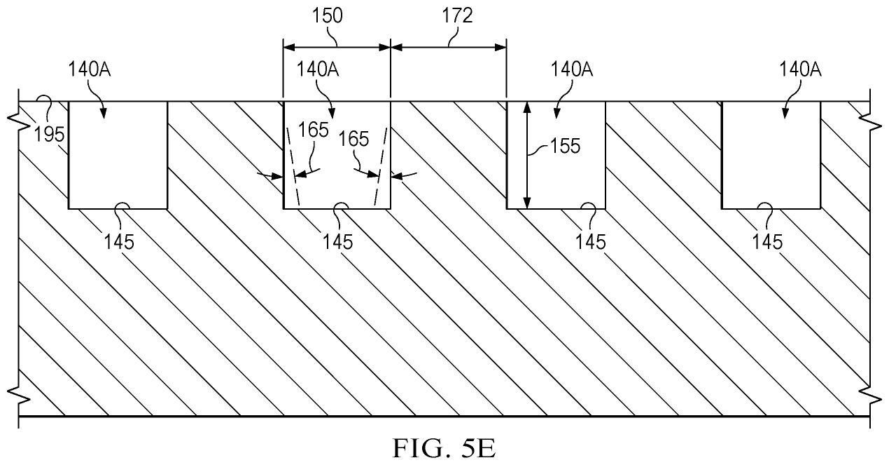

Referring to FIGS. 5A-5E, example housing 1000 is illustrated that includes first plurality of grooves 110B and a second plurality of grooves 140A that each have a length 160 that extends at an angle 170 of 90 degrees relative to lengths 130 of first plurality of grooves 110B (forming a plurality of “rectangular columns”). First plurality of grooves 110B and second plurality of grooves 140A can be formed in front portion 105 (FIG. 5A), rear portion 185 (FIG. 5B), or front portion 105 and rear portion 185 (FIG. 5C) of housing 1000, for example, by laser ablation.

Second plurality of grooves 140A each extend from top surface 195 of housing 1000 to a base 145 of each groove of second plurality of grooves 140A and can have a depth of 10 μm to 100 μm from top surface 195 to base 145 and a taper angle 165 between 0 degrees and 30 degrees from base 145 to top surface 195. A width 150 of each of second plurality of grooves 140A can be 20 μm to 100 μm at top surface 195, preferably between 40 μm and 80 μm. Second plurality of grooves 140A can be spaced apart by a distance 177 of 20 μm to 100 μm, preferably 40 μm to 80 μm, have a density of 10 to 50 grooves per mm², and cover an area of 50 mm² to 300 mm² of top surface 195.

Testing has shown that an aluminum plate having a first plurality of parallel grooves (e.g., first plurality of grooves 110B) and a second plurality of grooves (e.g., second plurality of grooves 140A) laser ablated/etched into the surface perpendicular to each other to form a plurality of “rectangular columns” provides a generally hydrophobic surface. In addition, an aluminum plate having a first plurality of parallel grooves (e.g., first plurality of grooves 110B) having a length oriented parallel to the blades (e.g., perpendicular to the direction of travel over the skin) and a second plurality of parallel grooves (e.g., second plurality of grooves 140A) having a length oriented perpendicular to the blades (e.g., parallel to the direction of travel over the skin) laser ablated/etched into the surface to form a plurality of “rectangular columns” has a lower coefficient of friction, on average, than an aluminum plate with no surface texturing with the surface dry and wetted with a shaving aid solution. However, the surface with the “rectangular columns” did show a higher coefficient of friction, on average, than an aluminum plate with no surface texturing with the surface wetted with water. Therefore, providing a first plurality of parallel grooves (e.g., first plurality of grooves 110B) having a length oriented parallel to the blades (e.g., perpendicular to the direction of travel over the skin) and a second plurality of parallel grooves (e.g., second plurality of grooves 140A) having a length oriented perpendicular to the blades (e.g., parallel to the direction of travel over the skin) laser ablated/etched into the front portion and/or rear portion of a housing of a shaving razor cartridge to form a plurality of “rectangular columns” will allow the housing to glide over the skin of a user more smoothly and easily than a housing with no textured surfaces in some circumstances.

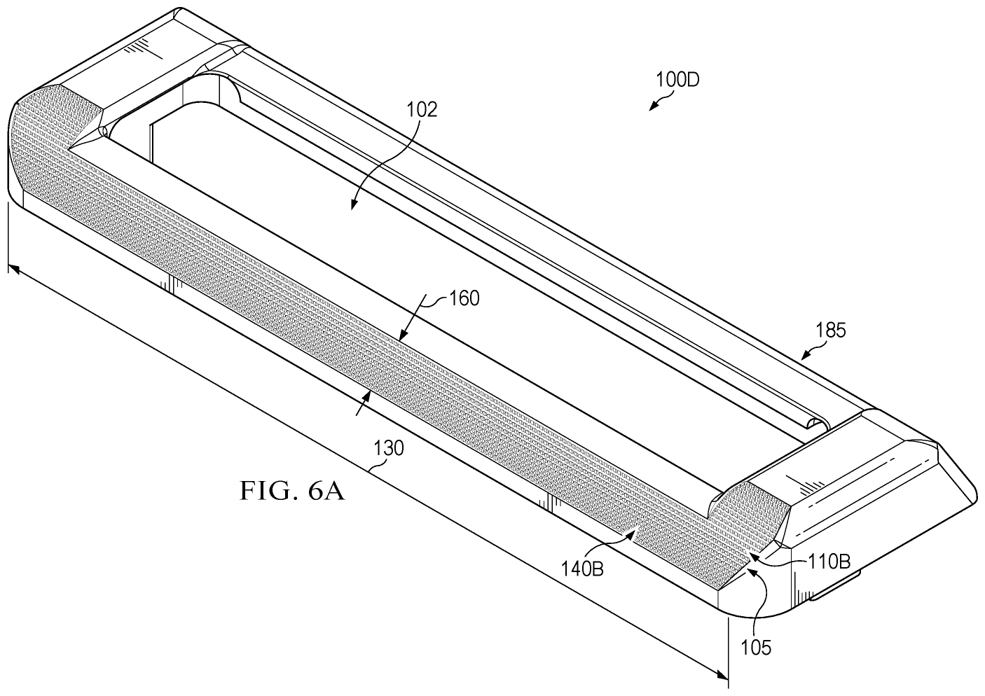

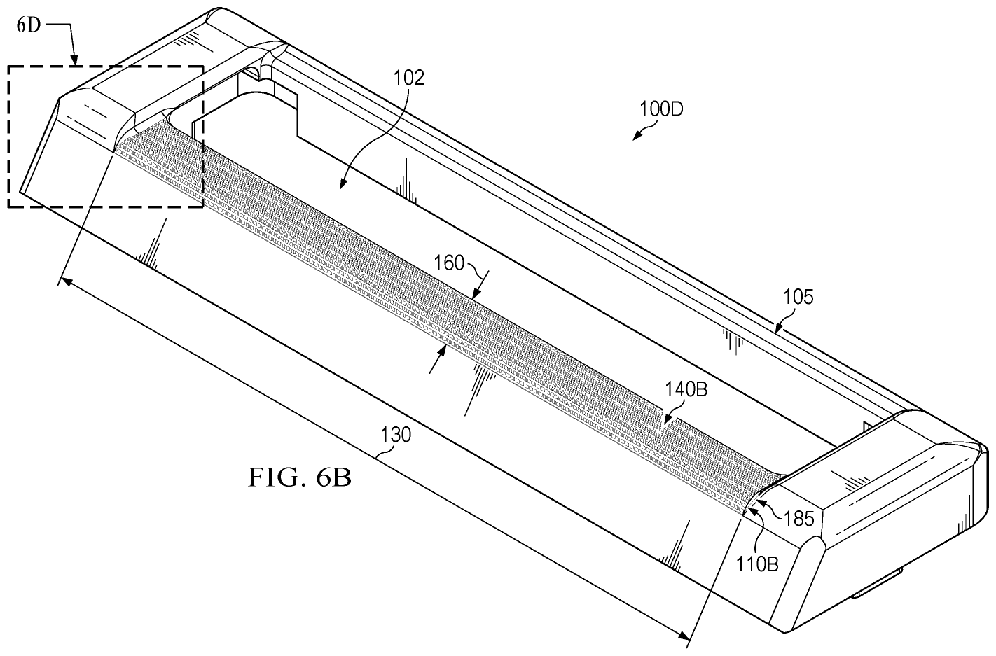

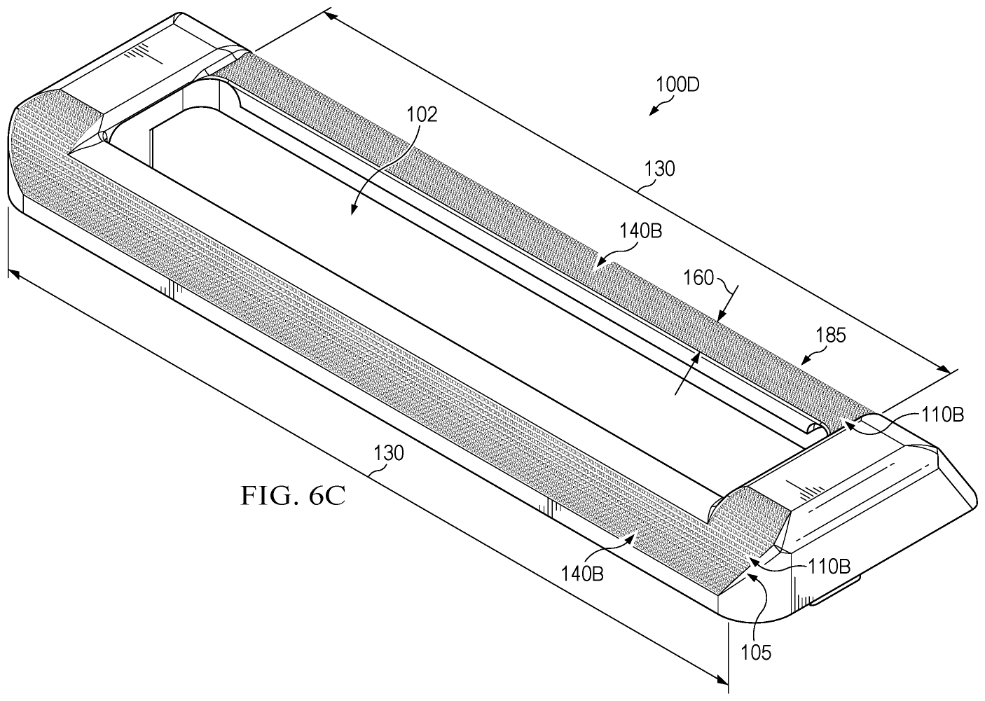

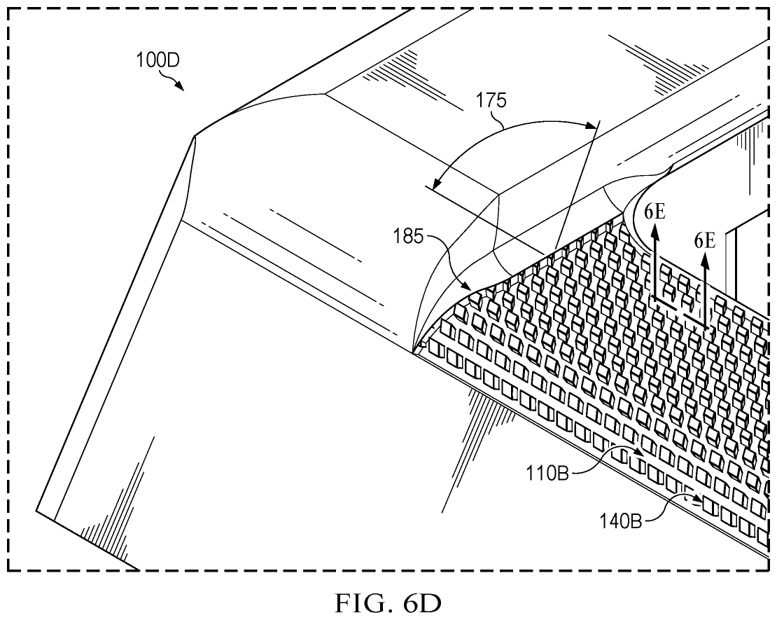

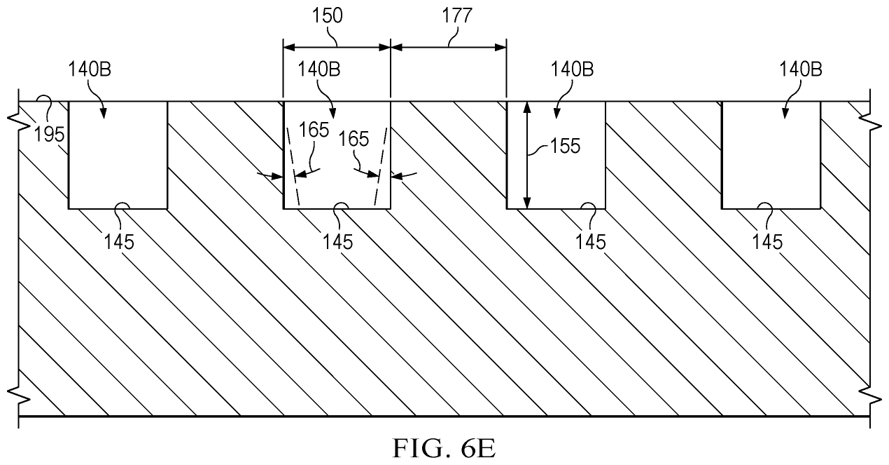

Referring to FIGS. 6A-6E, example housing 100D is illustrated that includes first plurality of grooves 110B and a second plurality of grooves 140B that each have a length 160 that extends at an angle 175 between 45 degrees and 75 degrees, in one embodiment 60 degrees, relative to lengths 130 of first plurality of grooves 110B (forming a plurality of “angled columns”). First plurality of grooves 110B and second plurality of grooves 140B can be formed in front portion 105 (FIG. 6A), rear portion 185 (FIG. 6B), or front portion 105 and rear portion 185 (FIG. 6C) of housing 100D, for example, by laser ablation.

Second plurality of grooves 140B each extend from top surface 195 of housing 100D to a base 145 of each groove of second plurality of grooves 140B and can have a depth of 10 μm to 100 μm from top surface 195 to base 145 and a taper angle 165 between 0 degrees and 30 degrees from base 145 to top surface 195. A width 150 of each of second plurality of grooves 140B can be 20 μm to 100 μm at top surface 195, preferably between 40 μm and 80 μm. Second plurality of grooves 140B can be spaced apart by a distance 172 of 20 μm to 100 μm, preferably 40 μm to 80 μm, have a density of 10 to 50 grooves per mm², and cover an area of 50 mm² to 300 mm² of top surface 195.

Testing has shown that an aluminum plate having a first plurality of parallel grooves (e.g., first plurality of grooves 110B) and a second plurality of grooves (e.g., second plurality of grooves 140B) laser ablated/etched into the surface at a 60 degree angle to each other to form a plurality of “angled columns” provides a generally hydrophilic surface. In addition, an aluminum plate having a first plurality of parallel grooves (e.g., first plurality of grooves 110B) having a length oriented parallel to the blades (e.g., perpendicular to the direction of travel over the skin) and a second plurality of parallel grooves (e.g., second plurality of grooves 140B) having a length oriented at a 60 degree angle to the length of the first plurality of grooves laser ablated/etched into the surface to form a plurality of “angled columns” has a lower coefficient of friction, on average, than an aluminum plate with no surface texturing with the surface dry. However, the surface with the “angled columns” did show a higher coefficient of friction, on average, than an aluminum plate with no surface texturing with the surface wetted with water and wetted with a shaving aid solution. Therefore, providing a first plurality of parallel grooves (e.g., first plurality of grooves 110B) having a length oriented parallel to the blades (e.g., perpendicular to the direction of travel over the skin) and a second plurality of parallel grooves (e.g., second plurality of grooves 140B) having a length oriented at a 60 degree angle to the length of the first plurality of grooves laser ablated/etched into the front portion and/or rear portion of a housing of a shaving razor cartridge to form a plurality of “angled columns” will allow the housing to grab and pull the skin tight better than a housing with no textured surfaces when the shaving razor cartridge is wetted with water or wetted with a shaving aid solution.

As described above, housing 100 can have first plurality of grooves 110A, 110B on front portion 105 and/or rear portion 185, can have first and second plurality of grooves 110B, 140A on front portion 105 and/or rear portion 185, or can have first and second plurality of grooves 110B, 140B on front portion 105 and rear portion 185. In addition, housing 100 can have any combination of groove patterns desired on front portion 105 and rear portion 185, depending on the particular application. For example, housing 100 can have first and second plurality of grooves 110B, 140B formed on front portion 105 to provide grip and pull the skin before it reaches blades 200 and can have no grooves, first plurality of grooves 110A, 110B, or first and second plurality of grooves 110B, 140A on rear portion 185 to allow rear portion 185 slide over the skin after engaged by blades 200. Alternatively, to allow housing 100 to slide over the skin without providing extra gripping of the skin, housing 100 can have first plurality of grooves 110A, 110B or first and second plurality of grooves 110B, 140A on front portion 105 and can have no grooves, first plurality of grooves 110A, 110B, or first and second plurality of grooves 110B, 140A on rear portion 185.

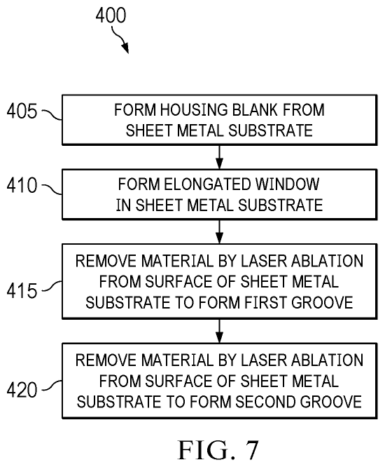

Referring to FIG. 7, an example method 400 for forming a housing (e.g., housing 100A, 100B, 1000, 100D) for a shaving razor cartridge (e.g., shaving razor cartridge 30) is illustrated.

At Step 405 of method 400, a housing blank is formed from a sheet metal substrate. Sheet metal substrate could be any metal material, such as aluminum, anodized aluminum, stainless steel, titanium, etc., and preferably has a Brinell hardness of 30 to 100. The housing blank may be formed using a punch press. However, it is understood other methods may be used, such as, CNC machining, laser machining, press brake equipment or other commonly used metal forming techniques and equipment.

At Step 410, an elongated window (e.g., elongated window 102) is formed in the sheet metal substrate.

At Step 415, material is removed by laser ablation from a surface of the sheet metal substrate adjacent the elongated window to a depth of 10 μm to 100 μm, preferably 40 μm to 60 μm, along a first continuous path to form a first groove (e.g., one of first plurality of grooves 110A, 110B). Preferably, the first groove is formed by laser ablating at least 25% of a total area of at least 100 mm².

At Step 420, material is removed by laser ablation from the surface of the sheet metal substrate adjacent the elongated window to a depth of 10 μm to 100 μm, preferably 40 μm to 60 μm, along a second continuous path to form a second groove. For example, if the first groove were one of first plurality of grooves 110A, 110B, the second groove could be a second one of first plurality of grooves 110A, 110B and could be formed parallel to the first groove and spaced apart from the first groove by 20 μm to 100 μm. In addition, if the first groove were one of first plurality of grooves 110A having a length that extends parallel to the elongated window, the second groove (e.g., one of second plurality of grooves 140A) could be formed perpendicular to the first groove or the second groove (e.g., one of second plurality of grooves 140B) could be formed at an angle between 45 degrees and 75 degrees, in one embodiment 60 degrees, relative to the length of the first groove.

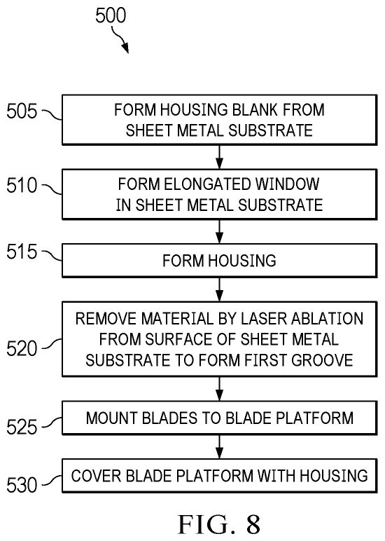

Referring to FIG. 8, an example method 500 for forming a shaving razor cartridge (e.g., shaving razor cartridge 30) is illustrated.

At Step 505 of method 500, a housing blank is formed from a sheet metal substrate. Sheet metal substrate could be any metal material, such as aluminum, anodized aluminum, stainless steel, titanium, etc., and preferably has a Brinell hardness of 30 to 100. The housing blank may be formed using a punch press. However, it is understood other methods may be used, such as, CNC machining, laser machining, press brake equipment or other commonly used metal forming techniques and equipment.

At Step 510, an elongated window (e.g., elongated window 102) is formed in the sheet metal substrate.

At Step 515, a housing (e.g., housing 100) is formed by forming one or more curved surfaces on the housing blank.

At Step 520, material is removed by laser ablation from a surface of the sheet metal substrate adjacent the elongated window to a depth of 10 μm to 100 μm, preferably 40 μm to 60 μm, along a first continuous path to form a first groove (e.g., one of first plurality of grooves 110A, 110B). Preferably, the first groove is formed by laser ablating at least 25% of a total area of at least 100 mm² of the sheet metal substrate adjacent the elongated window.

In addition, material can be removed by laser ablation from the surface of the sheet metal substrate adjacent the elongated window to a depth of 10 μm to 100 μm, preferably 40 μm to 60 μm, along a second continuous path to form a second groove. For example, if the first groove were one of first plurality of grooves 110A, 110B, the second groove could be a second one of first plurality of grooves 110A, 110B and could be formed parallel to the first groove and spaced apart from the first groove by 20 μm to 100 μm. In addition, if the first groove were one of first plurality of grooves 110A having a length that extends parallel to the elongated window, the second groove (e.g., one of second plurality of grooves 140A) could be formed perpendicular to the first groove or the second groove (e.g., one of second plurality of grooves 140B) could be formed at an angle between 45 degrees and 75 degrees, in one embodiment 60 degrees, relative to the length of the first groove.

At Step 525, one or more blades (e.g., blades 200) are mounted to a blade platform (e.g., blade platform 300).

At Step 530, the blade platform with the one or more blades mounted thereon is covered with the housing.

The dimensions and values disclosed herein are not to be understood as being strictly limited to the exact numerical values recited. The dimensions should not be held to an impossibly high standard of metaphysical identity that does not allow for discrepancies due to typical manufacturing and measuring tolerances. Therefore, the term “about” should be interpreted as being within typical manufacturing and measuring tolerances.

To the extent that any meaning or definition of a term in this document conflicts with any meaning or definition of the same term in another document, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor cartridge, comprising:
a housing having a front portion and a rear portion;
at least one blade having a respective cutting edge, the at least one blade retained within the housing and positioned between the front portion and the rear portion; and
at least one of the front portion and the rear portion having a first plurality of grooves extending from a top surface of the housing to a base of the groove, wherein the first plurality of grooves each have a width of 20 μm to 100 μm at the top surface and extend a depth of 10 μm to 100 μm from the base to the top surface.

2. The shaving razor cartridge of claim 1, wherein the widths of each of the first plurality of grooves extend perpendicular to the at least one blade and the first plurality of grooves each have a length extending parallel to the at least one blade of 1 mm to 40 mm.

3. The shaving razor cartridge of claim 2, wherein the at least one of the front portion and the rear portion has a second plurality of grooves extending from the top surface to a base of the groove, wherein the second plurality of grooves each have a width of 20 μm to 100 μm at the top surface, extend a depth of 10 μm to 100 μm from the base to the top surface, and have a length that extends at an angle between 45 degrees and 75 degrees relative to the lengths of the first plurality of grooves.

4. The shaving razor cartridge of claim 3, wherein the first plurality of grooves and the second plurality of grooves are in the front portion of the housing.

5. The shaving razor cartridge of claim 1, wherein the first plurality of grooves are in the rear portion of the housing.

6. The shaving razor cartridge of claim 5, wherein the widths of each of the first plurality of grooves extend parallel to the at least one blade and the first plurality of grooves each have a length extending perpendicular to the at least one blade of 1 mm to 8 mm at the top surface.

7. The shaving razor cartridge of claim 5, wherein the widths of each of the first plurality of grooves extend perpendicular to the at least one blade and the first plurality of grooves each have a length extending parallel to the at least one blade of 1 mm to 40 mm at the top surface.

8. The shaving razor cartridge of claim 5, wherein the rear portion has a second plurality of grooves extending from the top surface to a base of the groove, wherein the second plurality of grooves each have a width of 20 μm to 100 μm at the top surface, extend a depth of 10 μm to 100 μm from the base to the top surface, and have a length that extends at an angle of 90 degrees relative to the lengths of the first plurality of grooves.

9. The shaving razor cartridge of claim 1, comprising a blade platform, wherein the at least one blade is mounted to the blade platform and the housing covers the blade platform.

10. The shaving razor cartridge of claim 1, wherein the first plurality of grooves are spaced apart by a distance of 20 μm to 100 μm.

11. The shaving razor cartridge of claim 1, wherein the first plurality of grooves each have a width extending parallel to the at least one blade of 40 μm to 80 μm at the top surface.

12. The shaving razor cartridge of claim 1, wherein the first plurality of grooves have a taper angle from the base to the top surface of 0 degrees to 30 degrees.

13. The shaving razor cartridge of claim 1, wherein the first plurality of grooves have a density of 10 to 50 grooves per mm² and cover an area of 50 mm² to 300 mm² of the top surface of the housing.

14. A method of forming a housing for a shaving razor cartridge, comprising:
forming a housing blank from a sheet metal substrate;
forming an elongated window in the sheet metal substrate; and
removing material from a surface of the sheet metal substrate adjacent the elongated window to a depth of 10 μm to 100 μm by laser ablation along a first continuous path to form a first groove.

15. The method of claim 14, wherein said removing material comprises laser ablating at least 25% of a total area of at least 100 mm².

16. The method of claim 14, further comprising removing material from the surface of the sheet metal substrate adjacent the elongated window to a depth of 10 μm to 100 μm by laser ablation along a second continuous path to form a second groove parallel to the first groove and spaced apart from the first groove by 20 μm to 100 μm.

17. The method of claim 14, further comprising removing material from the surface of the sheet metal substrate adjacent the elongated window to a depth of 10 μm to 100 μm by laser ablation along a second continuous path to form a second groove perpendicular to the first groove.

18. The method of claim 14, further comprising removing material from the surface of the sheet metal substrate adjacent the elongated window to a depth of 10 μm to 100 μm by laser ablation along a second continuous path to form a second groove having a length that extends at an angle between 45 degrees and 75 degrees relative to a length of the first groove.

19. The method of claim 14, wherein a length of the first groove is parallel to a length of the elongated window and extends at least 50% of the length of the elongated window.

20. A method of forming a shaving razor cartridge, comprising:
forming a housing blank from a sheet metal substrate;
forming an elongated window in the sheet metal substrate;
forming a housing by forming one or more curved surfaces on the housing blank;
removing material from a surface of the sheet metal substrate to a depth of 10 μm to 100 μm by laser ablation along a first continuous path;
mounting one or more blades to a blade platform; and
covering the blade platform with the housing.
